(19) United States
(12) Patent Application Publication
(10) Pub. No.: US 2002/0061400 A1
(43) Pub. Date: May 23, 2002

(54) Method of reuse of waste wood and recycled wood product obtained thereby

(76) Inventor: Peter Rossler, Ilsfeld (DE)

Correspondence Address: Jody L. Factor, FACTOR & PARTNERS, LLC, 100 W. Monroe St., Suite 300, Chicago, IL, 60603, US

(21) Appl. No.: 09/792,555

(22) Filed: Feb. 23, 2001

(30) Foreign Application Priority Data
Nov. 17, 2000 (DE) 100 58 843.4

(51) Int. Cl. B02C 19/00; B32B 5/16; B32B 9/00; B32B 15/02; B32B 17/02; B32B 19/00; B32B 21/02; B32B 23/02; B32B 27/02

(52) U.S. Cl. 428/402; 428/407; 428/403; 241/1

(57) ABSTRACT

For reuse of waste wood obtained in the production of windows, furnitures and chip board it is suggested to diminute the waste wood to particles, the diameter of which is in the region of some 10 mm. The thus obtained wood particles are coloured to form a granulate material, which can be used for decorative purposes.

The invention relates to method for reuse of waste wood as well as to a recycled wood product obtained thereby.

It is known to reuse waste wood, e.g. waste wood obtained in the production of windows, furniture or chipboard as a firing material. In such reuse the waste wood is first diminuted into chips or granulate material, which, if desired, is formed into briquettes of essentially uniform dimensions using a press. A suitable diminuting machine is disclosed in DE 92 15 319 U1. The briquettes made from chips of wood particles are used for combustion in special furnaces which serve for heating purposes.

However, there are regions, where no heating is required or where no special furnaces apt to be fired by wood briquettes are available for heating purposes. In such regions there there is a problem as to disposal of waste wood.

It is an object of the present invention to solve the above mentioned problem in disposal of waste wood.

For solving this problem the invention proposes a method for reuse of waste wood and a recycled wood product obtained by such method.

In the method in accordance with the invention the waste wood is diminuted to particles, the size of which is about 0,1 until about 50 mm. Preferred ranges of particle diameters are between about 0,1 and about 20 mm and again preferred between about 1,0 and 10 mm. The wood particles ground to the above sizes are subject to a dyeing or colouring step.

Thus the method in accordance with the invention provides a coloured wood material which can be handled like sand or a granulate material. The dyeing or colouring can be made using all kinds of dyes and colouring agents apt to be solved in a solvent without recurring to a binding agent. The solvent may be an organic or aqueous solvent.

In particular those solvable dyes or colouring agents can be used which are cited in the colour index (Bradford: Society of Dyers and Colourists 1971, 1975).

Further advantageous improvements of the process in accordance with invention relate to the following:

For environmental reasons water solvable (ionic) dyes or colouring agents are preferred, since there are no organic solvent vapours that must be disposed. The dyes or colouring agents can be of the cationic or anionic type. The water component is removed by volatilazation or evaporation at elevated temperature until the wood has been completely dried.

The method for applying the dye or colouring agent can be put into practice by very simple means: The colouring or dyeing solution and the diminuted waste wood are mixed in a drum mixer until the wood has accepted the dye or colouring agent. Thereafter the wood particles are separated from the remnant solution by decantation or using a sieve or screen. Thereafter the wood material is dried. The rest of the solution can be supplemented as to the dye or colouring agent and can be reused thereafter.

It is preferred to remove wood dust from the diminuted waste wood before the dying or colouring step by a sieving or blowing step. Wood dust is less desirable in some of the applications of the coloured wood product described hereinafter, since wood dust can enter the respiritory tract. Also wood dust is generally difficult to recover.

Unless only small quantities of the diminuted wood material are used, it is preferred to apply a flame protecting or flame inhibiting agent to the material. The most suitable flame inhibiting agents are of the water solvable type, i.e. (NH₄)₂HPO₄. Such flame inhibiting agents can be applied to the waste wood in the same way as the dyes or colouring agents using a drum type mixer. Eventually, the flame inhibiting substances can be added to the wood particles simultaneously with the dyes or colouring agents.

If the coloured diminuted waste material is used under open air conditions, it is preferred to add a wood protecting agent protecting the wood against the effects of bacteria, fungi, destructors and the like. In such case, again, water solvable agents are preferred, e.g. salts which have a chromate-copper salt-borate or -arsenate base. The wood protecting agents can be applied to the diminuted wood material using a drum type mixer, if desired together with the dyeing or colouring agent and/or a flame inhibiting agent. It is preferred that the wood protecting agent is impregnated into the wood particles.

Furthermore, the coloured diminuted wood material can be covered with paint layer. Thus the resistance to atmospheric corrosion of the wood material is improved. The paint or lacquer can be a decorative paint or lacquer including metallic particles.

The paint or lacquer can be applied in a modified fluidized bed reactor. Therein the diminuted wood material forms a bed which is kept in a fluidized suspended condition by means of an inert gas, e.g. air or nitrogene. The paint or lacquer is sprayed onto the upper surface of the fluidized bed. By keeping the fluidized bed in motion by means of the inert gas it is warranted that the particles will not cling together by intermediary of the paint coat and will be dried while in motion. Thus the particles can be removed from the fluidized bed after drying in a finely distributed dry condition.

A second object of the invention resides in the provision of a diminuted waste wood material, wherein the size of the particles is between about 0,1 and about 50 mm, preferably between about 0,1 mm and about 20 mm and again preferably between about 1,0 and 10 mm, the particles being coloured.

Diminuted granulate wood material can be used for open air applications and for playing purposes, since the wood particles can be easily recollected, if desired. Such coloured wood chips or wood particles can also be used in the production of compound material, which is coloured in the volume. To this end a binding agent is added to the coloured particles and the mass thus obtained is formed into the desired shape by pressing. If intermediate products are produced that way (e.g. board material), these intermediate products can be cut to final products in arbitrary ways and it is not necessary to provide for separate colouring of the surfaces formed in the cutting process.

The coloured diminuted wood material can also be used for decorative or artists's purposes. In such applications it can be used in similar way as coloured sand. For example two or three dimensional “sand” images can be formed. Another application is filling of transparent vessels with coloured wood material layers or coloured wood material rings. These layer structures can then be given interesting and pleasant patterns by stirring.

The material provided by the invention can also be used as a substitute for sand in “sand boxes” for use by children, which in such case can be also be placed within a house. Furthermore, the coloured diminuted wood particles can be distributed on ground surfaces, e.g. flower beds, where one wants to eliminate growth of weed. In such case a decorative effect is obtained together with the weed suppressing characteristics normally provided by diminuted bark material.

It is further contemplated that the coloured diminuted wood material is given flame inhibiting properties by applying a flame inhibiting agent thereto. Thus the danger of fire is reduced.

It is further contemplated that the coloured diminuted wood material has a wood protecting agent applied thereto. Thus the material in accordance with the present invention will not deteriorate under the influence of weather, bacteria and fungi.

In view of further improving the corrosion resistivity of the coloured diminuted wood material this material can be provided with a paint or lacquer coating. This coating is also advantageous in view of a more pleasant appearance of the wood material. A particularly appealing decorating material is obtained, if the diminuted wood material is coated with a metallic paint.

Preferred embodiments of the invention will now be explained in more detail referring to the drawings. Therein

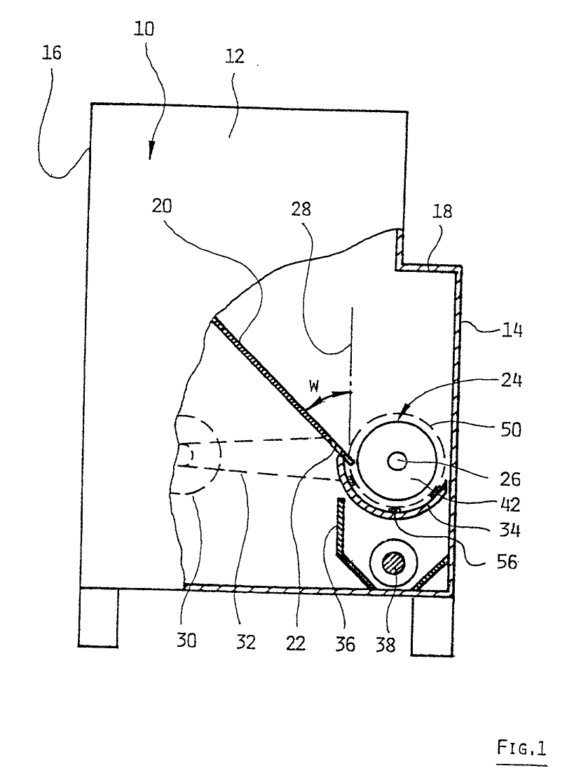

FIG. 1: is a schematic vertical section through a machine for diminuting waste wood;

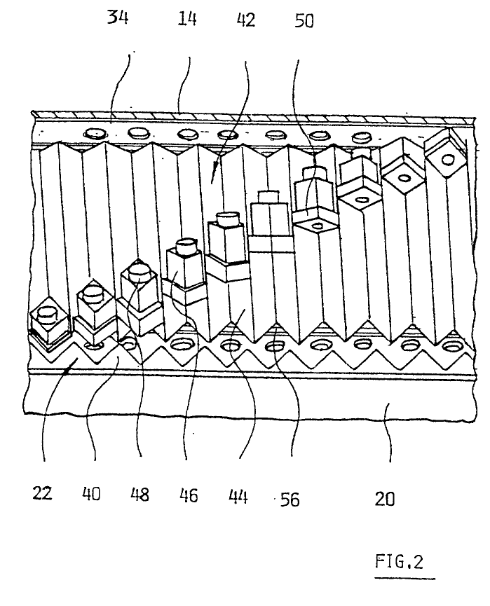

FIG. 2: is a plan view of a portion of the region of interengagement of a diminuting drum and a counter blade of the diminuting machine of FIG. 1 shown in increased scale;

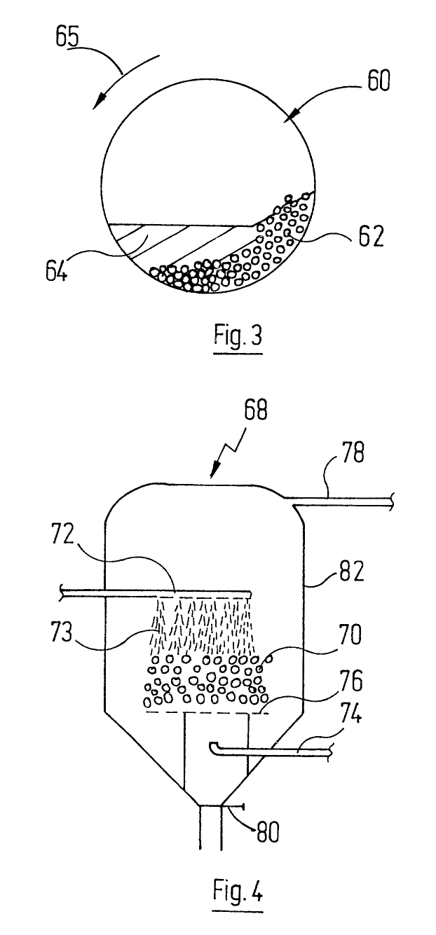

FIG. 3: is a schematic vertical section through a drum type mixer in which diminuted waste wood material is mixed with a dyeing or colouring solution; and

FIG. 4: is a schematic vertical section through a fluidized bed reactor in which the coloured diminuted wood material is coated with a paint.

Diminuting of waste wood, e.g. waste wood obtained in the productions of windows, the production of furniture and the production of chipboard can be effected using a diminuting machine as shown in FIG. 1. In FIG. 1 10 is a hopper for waste wood to be diminuted. Hopper 10 has lateral walls 12, front wall 14, a rear wall 16 as well as an upper wall 18. A bottom wall 20 closes the lower side of hopper 10. Bottom wall 20 slopes down from the rear wall 16 to the front wall 14. Its angle of inclination is about 45°

A counter blade 22 of the zig-zag shape is fixed the forward end of the bottom wall 20.

A diminuting drum 24 operates with the counter blade 22. The play between the outer effective contour of the diminuting drum 24 and the counter blade 22 is about 1 to 2 mm. The diminuting drum 24 is journalled in the lateral walls 12 by means of lateral stub shafts 26 and bearings not shown in the drawings.

As may be seen from the drawings, the diameter of the diminuting drum 24 is chosen so that the right hand end of the diminuting drum 24 (as seen in FIG. 1) runs under small play in front of the interior surface of the front wall 14. Furthermore, the distances defined between the axis of the diminuting wall 24 and the downwardly sloped plane defined by the bottom wall 20 is chosen such that the angle w, defined between the plane of bottom wall 20 and a tangential plane 28 of the diminuting drum 24 adjacent to the free edge of the counter plate 22 is about 60°.

The diminuting drum 24 is driven by an electric motor 30 and a belt drive 32. The electric motor is carried by the rear lateral wall 12.

An essentially semicylindrical sieve member 34 extends around the diminuting drum 24 in essentially parallel spaced relationship. The distance between the sieve member 34 and the diminuting drum 24 is between about 5 and 10 mm. The acutal distance is chosen considering the dimensions of the diminuting machine and in first line considering the waste material to be diminuted.

The sieve openings not shown in detail in the drawings typically have a diameter of about 5 to about 20 mm, the distance defined between the centers of the sieve opening being between about 10 to about 30 mm. Thus the width of the lands defined between the sieve openings is about 5 to about 10 mm. The sieve openings are arranged along lines extending parallel ot the axis of diminuting drum 34.

Below the sieve member 34 and extending parallel to the axis thereof there is a collecting chute 36 for diminuted waste wood. A feed screw 38 is arranged so as to rotate within the collecting chute. The feed screw 38 feeds the diminuted wood material to a storage container.

As may be seen from FIG. 2, the counter blade 28 comprises a plurality of successive teeth 44 each having the form a isosceles right angle triangle. The diminuting drum 24 has a drum core 42 obtained by staggering a plurality of disks 44, each of the disks having a peripheral portion of right angle isosceles section.

Between each pair of two adjacent disks 44 there are blade carriers 46 welded to the disks 44. Cutting blades 50 are fixed to the blade carriers 46 by means of mounting screws 48.

The distance defined between the diminuting drum 34 and the counter blade 22 can be adjusted such that the average particle size of the diminuted wood material is between 5 mm and 50 mm. In connection with smaller particle sizes diminuting machines are used, wherein the gap defined between the diminuting rotor and the counter blade can be adjusted to smaller values. Such a diminuting machine is disclosed in EP 0 419 919 B1.

FIG. 3 shows a drum type mixer 60, wherein the diminuted waste wood 62 is mixed with a dyeing or colouring solution 64. The drum mixer is rotated in the sense of an arrow 65 by means of a motor not shown in the drawings. Once a sufficient quantity of dye or colouring agent has been absorbed by deposited on the diminuted waste wood 62, the wood particles are separated from the remnant dye or colouring solution 64 by decantation or filtration using a sieve (not shown).

A flame inhibiting agents and/or a wood protecting agent can also be applied to the diminuted wood material using the drum mixer 60. In such case reference numeral 62 designates the already coloured diminuted waste wood while reference numerals 64 designates a flame inhibiting solution and/or a wood protecting solution. Separation of excessive solution from the solid particles is again achieved by decantation or using a sieve (not shown). Drying of the coloured diminuted waste wood material can be achieved under atmospheric conditions or at elevated temperatures.

FIG. 4 shows a fluidized bed reactor, wherein the colour diminuted wood material can be coated with a paint or lacquer, if desired. A fluidized bed 70 is formed by the coloured diminuted wood material, which is kept in motion by air or an inert gas provided by a line 74 and being discharged from a distributing plate 76. A nozzle pipe 72 discharges a spray 73 of paint or lacquer material onto the fluidized bed comprising the coloured diminuted waste wood. The paint or lacquer preferably is a water based paint or lacquer. After termination of the spraying of paint or lacquer the wood material will still be kept in the fluidized bed so that will dried in the fluidized bed and the particles will not cling together.

The solvent carried away by the fluidizing gas is recovered by a pipe 78 merging from the upper end of the reactor. The paint coated coloured diminuted wood material is removed from the reactor by opening a slide valve 80.

1. A method of reuse of waste wood, wherein waste wood is diminuted to a particle size of about 0,1 to 50 mm and the diminuted wood material is coloured.

2. The method as in claim 1, wherein the waste wood is diminuted to a diameter of about 0,1 to about 20 mm.

3. The method as in claim 2, wherein the waste wood is diminuted to a diameter of about 1,0 to about 10 mm.

4. The method as in claim 1, characterized in that colouring of the diminuted waste wood material is carried out using water solvable cationic or anionic dyes or colouring agents.

5. The method as in claim 1, characterized in that colouring of the diminuted wood material is carried out in a drum mixer.

6. The method as in claim 1, wherein the diminuted wood material is subject to a sizing step to remove wood dust.

7. The method as in claim 1, wherein the coloured diminuted wood material is treated with a flame inhibiting agent.

8. The method as in claim 1, wherein the coloured diminuted wood material is treated with a wood protecting agent.

9. The method as in claim 1, wherein the coloured diminuted wood material is coated with a paint or lacquer.

10. The method as in claim 9, wherein the paint is a paint containing metallic particles.

11. A diminuted waste wood material having a particle size of about 0,1 to about 50 mm, the particles being coloured.

12. The material as in claim 11, wherein the diameter of the particles is between about 0,1 mm and about 20 mm.

13. The material as in claim 12, wherein the diameter of the particles is between about 1 mm and 10 mm.

14. The material as in claim 11, wherein the wood particles are treated with a flame inhibiting agents.

15. The material as in claim 11, wherein the wood particles are treated with a wood protecting agent.

16. The material as in claim 11, wherein the diminuted wood material is coated with a paint.

17. The material as in claim 16, wherein the paint contains metallic particles.
